(19) United States
(12) Patent Application Publication
(10) Pub. No.: US 2014/0176823 A1
(43) Pub. Date: Jun. 26, 2014

(54) TOUCH PANEL

(71) Applicant: SAMSUNG ELECTRO-MECHANICS CO., LTD., Suwon (KR)

(72) Inventors: Kee Su Jeon, Suwon (KR); Kyoung Jin Jeong, Suwon (KR); Jai Hyoung Gil, Suwon (KR); Tae Hoon Kim, Suwon (KR)

(21) Appl. No.: 13/911,992

(22) Filed: Jun. 6, 2013

(30) Foreign Application Priority Data
Dec. 21, 2012 (KR) 10-2012-0150925

(51) Int. Cl. G06F 1/16

(52) U.S. Cl. CPC G06F 1/169
USPC 349/12

(57) ABSTRACT

Disclosed herein is a touch panel, including: a transparent substrate divided into an active area and a non-active area, which is an outer region of the active area; electrodes formed on one surface of the transparent substrate; and a bezel formed in the non-active area of one surface of the transparent substrate, wherein the bezel is formed of a bezel composition containing silane and a pigment.

### CROSS REFERENCE TO RELATED APPLICATION

This application claims the benefit of Korean Patent Application No. 10-2012-0150925, filed on Dec. 21, 2012, entitled “Touch Panel”, which is hereby incorporated by reference in its entirety into this application.

### BACKGROUND OF THE INVENTION

1. Technical Field

The present invention relates to a touch panel.

2. Description of the Related Art

Recently, with the development of computers using a digital technology, devices assisting computers have also been developed, and personal computers, portable transmitters and other personal information processors execute text and graphic processing using a variety of input devices such as a keyboard and a mouse.

While the rapid advancement of an information-oriented society has been widening the use of computers more and more, it is difficult to efficiently operate products using only a keyboard and mouse currently serving as an input device. Therefore, the need for a device that is simple, has minimum malfunction, and is capable of easily inputting information has increased.

In addition, current techniques for input devices have progressed toward techniques related to high reliability, durability, innovation, designing and processing beyond the level of satisfying general functions. To attain these objects, a touch panel has been developed as an input device capable of inputting information such as text, graphics, or the like.

The touch panel is mounted on the display surface of an image display device such as an electronic organizer, a flat panel display including a liquid crystal display device (LCD), a plasma display panel (PDP), an electroluminescence (El) element or the like, or a cathode ray tube (CRT), so that a user selects the desired information while viewing the image display device.

The touch panel is classified into a resistive type touch panel, a capacitive type touch panel, an electromagnetic type touch panel, a surface acoustic wave (SAW) type touch panel, and an infrared type touch panel. These various types of touch panels are adapted for electronic products in consideration of signal amplification problems, resolution difference, level of difficulty of designing and processing technologies, optical characteristics, electrical characteristics, mechanical characteristics, environment-resistant characteristics, input characteristics, durability, and economic efficiency. Currently, a capacitive type touch panel and a resistive type touch panel have been used in a wide range of fields.

As for this touch panel, on a window glass provided at the outermost region of a general touch panel structure, electrode wires are shielded or a bezel part having black, white, or the like, for forming decoration patterns, is formed.

Korean Patent Laid-Open Publication No. 2010-0134226 discloses a touch panel as a specific example of a touch panel having a bezel part of the prior art.

However, the touch panel of the prior art has problems in that disconnection or cracks may occur in an electrode due to the step height at the time of forming the electrode in the bezel part.

### PRIOR ART DOCUMENT

### Patent Document

(Patent Document 1) Korean Patent Laid-Open Publication No. 2010-0134226

### SUMMARY OF THE INVENTION

The present invention has been made in an effort to provide a touch panel capable of stably forming electrodes in a bezel.

According to a preferred embodiment of the present invention, there is provided a touch panel, including: a transparent substrate divided into an active area and a non-active area, which is an outer region of the active area; electrodes formed on one surface of the transparent substrate; and a bezel formed in the non-active area of one surface of the transparent substrate, wherein the bezel is formed of a bezel composition containing silane and a pigment.

The bezel may include a slope portion slopingly formed on a lateral end part thereof

The slope portion may have a slope in which a height of the slope portion becomes gradually decreased toward the active area.

Here, an angle between one surface of the transparent substrate and a slope surface of the slope portion may be 10°˜80°.

The electrode may be formed throughout the active area and the non-active area of the transparent substrate, and formed along one surface of the bezel.

The electrode may include: a touch electrode formed in the active area of the transparent substrate; and an electrode wire formed in the non-active area of the transparent substrate, the electrode wire being formed along one surface of the bezel.

The touch panel may further include a shielding layer formed of an insulating material between the bezel and the electrode.

The bezel composition may further contain a pigment dispersant.

The bezel composition may further contain a binder resin.

The bezel composition may further contain a solvent.

The bezel composition may further contain a photo-polymerizable compound and a photo-initiator.

The bezel composition may further contain one or more additives of a polymer compound, a hardener, a surfactant, an adhesion promoter, an anti-oxidant, a UV absorbent, and an anti-cohesive agent.

The pigment may include titanium dioxide (TiO₂) or carbon black.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plane view showing a transparent substrate in a touch panel according to a preferred embodiment of the present invention;

FIG. 2 is a cross-sectional view showing the touch panel according to the preferred embodiment of the present invention; and

FIG. 3 is a cross-sectional view obtained by enlarging Region A shown in FIG. 2.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

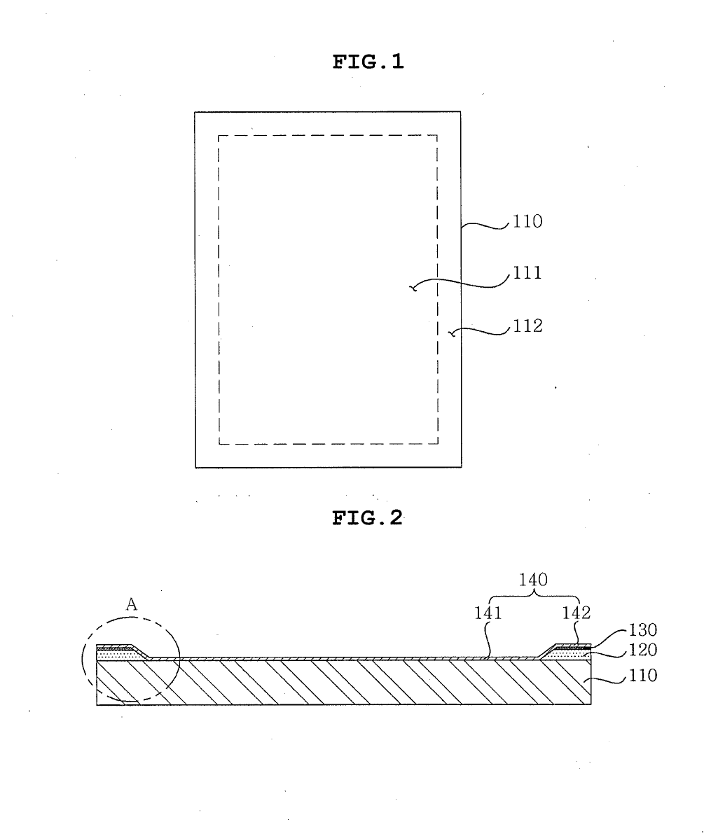

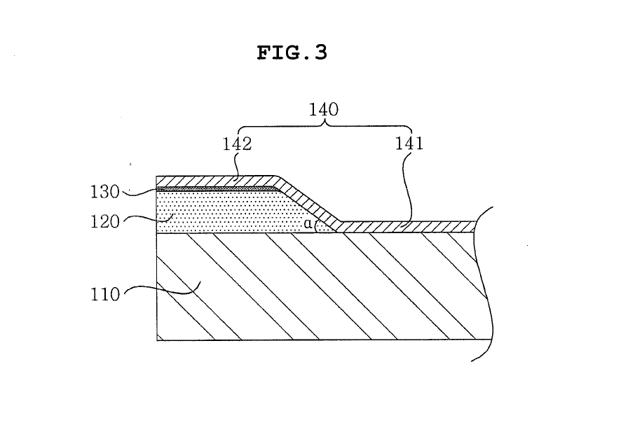

FIG. 1 is a plane view showing a transparent substrate in a touch panel according to a preferred embodiment of the present invention; FIG. 2 is a cross-sectional view showing the touch panel according to the preferred embodiment of the present invention; and FIG. 3 is a cross-sectional view obtained by enlarging Region A shown in FIG. 2.

Referring to FIGS. 1 TO 3, a touch panel having a bezel composition, according to a preferred embodiment of the present invention may include: a transparent substrate 110 divided into an active area 111 and a non-active area 112, which is an outer region of the active area 111; and a bezel 120 made of a bezel composition and formed in the non-active area 112 of one surface of the transparent substrate 110.

More specifically, the transparent substrate 110 may serve to provide an area in which electrodes 140 for sensing a touch position are to be formed. The transparent substrate 110 needs to have a support force for supporting the electrodes 140 and transparency for allowing a user to recognize an image provided by an image display device.

In consideration of the foregoing support force and transparency, the transparent substrate 110 is preferably formed of polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or reinforced glass, or like, but is not particularly limited thereto.

Meanwhile, the transparent substrate 110 may be divided into an active area 111 and a non-active area 112 as an edge region of the active area 111, as shown in FIG. 1. The active area 111 is an area where a user inputs a touch, and also a screen area in which a motion scene of the touch panel is visibly recognized by the user. In addition, the non-active area 112 is an area which is shielded by the below-described bezel 120 formed on the transparent substrate 110 and thus is not exposed to the outside.

The bezel 120 is formed in the non-active area 112 on one surface of the transparent substrate 110 (see, FIG. 1). In addition, the bezel 120 may serve to shield one side of the electrodes 140, which is disposed in an area corresponding to the non-active area 112 of the transparent substrate 110. In addition, a decoration pattern such as a logo of a manufacturer may be formed in the bezel 120, as necessary.

In addition, the bezel 120 includes a slope portion slopingly formed on a lateral end part thereof Here, the slope portion has a slope of which a height becomes gradually decreased toward the active area 111 of the transparent substrate 110. Herein, an angle (a) between one surface of the transparent substrate 110 and a slope surface of the bezel 120 is 90° or lower. More specifically, the angle (a) between one surface of the transparent substrate 110 and the slope surface of the bezel 120 may be 10°˜40°.

In addition, the bezel 120 may be formed of a bezel composition containing silane, a colorant, and a binder resin. Also, the bezel composition may further contain a photo-polymerizable compound, a photo-initiator, a solvent, and additives.

The silane is contained in the bezel composition, and has adhesive property for forming the slope portion of the bezel 120. Here, the silane may be RSi(OC_{N}H_{2N}H)₃, and may be, for example, vinyltriethoxysilane.

The colorant may be composed of a colorant composition containing a pigment and a pigment dispersant.

Here, the pigment may include titanium dioxide (TiO₂) or carbon black, but the kind of pigment of the present invention is not limited thereto. Titanium dioxide is a white pigment, and may be contained in 50 to 90 mass % in terms of mass fraction, based on the solid content in the colorant composition. Here, for example, 65 to 85 mass % of titanium dioxide may be contained in the colorant composition.

In addition, the pigment dispersant may be any one or a combination of one or more, of, for example, a polyester based polymer dispersant, an acrylic based polymer dispersant, a phosphoric ester based dispersant, a polyurethane based dispersant, an anionic based surfactant, a cationic based surfactant, and a non-ionic based surfactant. The content of the pigment dispersant is contained in 1 to 10 parts by weight based on 100 parts by weight of pigment and/or dye. If the content of the pigment dispersant is within the above range, a uniform dispersion state of pigment tends to be obtained, which is preferable.

The binder resin may be any one or more of gelatin, polyvinyl alcohol (PVA), polyvinyl pyrrolidone (PVP), polysaccharides such as starch, cellulose and its derivatives, polyethylene oxide, polyvinyl amine, chitosan, poly lysine, polyacrylic acid, poly alginic acid, poly hyaluronic acid, and carboxy cellulose.

The photo-polymerizable compound is a compound capable of being polymerized by a light and a reaction of a photo-initiator, and may be any one or more of a mono-functional monomer, a bi-functional monomer, and other multi-functional monomers.

The photo-initiator may be any one or more of a triazine based compound, an actophenone based compound, a non-imidazole based compound, and an oxim compound.

As the solvent, ethers, aromatic hydrocarbons, ketones, alcohols, esters, amides, or the like, may be used.

The additives may be a polymer compound, a hardener, a surfactant, an adhesion promoter, an anti-oxidant, a UV absorbent, an anti-cohesive agent, and the like.

The electrodes 140 may be formed on one surface of the transparent substrate 110, and may be formed throughout the active area and the non-active area of the transparent substrate 110. Here, the electrodes 140 may be formed along one surface of the bezel 120. Here, one surface of the bezel 120 may be an upper surface of the bezel 120 in FIGS. 2 and 3.

In addition, the electrode 140 may include a touch electrode 141 formed in the active area and an electrode wire 142 formed in the non-active area of the transparent substrate 110. Here, the electrode wire 142 may be formed on one surface of the bezel 120. Here, the electrode wire 142 is formed in an outer region of the touch electrode 141 to receive an electric signal from the touch electrode 141.

Specifically, the electrodes 140 may be formed in a mesh pattern, by using copper (Cu), aluminum (Al), gold (Au), silver (Ag), titanium (Ti), palladium (Pd), chrome (Cr), or a combination thereof. Here, the electrodes 140 may be formed by a plating process or a depositing process. Meanwhile, in the case where the electrodes 140 are formed of copper (Cu), surfaces of the electrodes 140 are preferably subjected to blackening treatment. Here, with respect to the blackening treatment, the surface of the electrode 140 is oxidized to precipitate Cu₂O or CuO. Cu₂O is called brown oxide because it exhibits brown color, and CuO is called black oxide because it exhibits black color. As such, the surfaces of the electrodes 140 are subjected to the blackening treatment, thereby preventing a light from being reflected, and thus improving visibility of the touch panel 100.

In addition, the electrodes 140 may have a line width of 7 μm or less and a pitch of 900 μm or less, to thereby improve visibility. However, the line width and pitch of the electrodes 140 according to preferred embodiment of the present invention are not limited thereto.

Meanwhile, the electrodes 140 may be formed by metal silver, which is obtained by exposing/developing a silver salt emulsion layer, besides the foregoing metal.

In addition, the electrodes 140 may be formed in a surface type by using a conductive polymer or metal oxide.

Here, the conductive polymer has excellent flexibility and a coating process thereof is simple. Here, the conductive polymer may include poly-3,4-ethylenedioxythiophene/polystyrenesulfonate (PEDOT/PSS), polyaniline, polyacetylene, and polyphenylenevinylene.

In addition, the metal oxide may be indium-tin oxide.

In addition, when the electrodes 140 are formed by the conductive polymer or the metal oxide, they may be formed by a drying process, a wetting process, or a direct patterning process. Here, the drying process means sputtering, evaporation, or the like; the wetting process means dip coating, spin coating, roll coating, spray coating, or the like; and the direct patterning process means screen printing, gravure printing, inkjet printing, or the like.

Here, when the electrodes 140 are formed of the conductive polymer or the metal oxide, they may be formed in a pole shape on the drawing, but are not limited thereto, The electrodes 140 may be formed in any patterns known in the art, such as, a diamond pattern, a square pattern, a triangle pattern, a circle pattern, or the like.

Meanwhile, the touch panel according to the preferred embodiment of the present invention may further include a shielding layer 130 formed between the bezel 120 and the electrode 140. Here, the shielding layer 130 is formed of an insulating material, and thus can prevent current conduction between the bezel 120 and the electrode 140.

As set forth above, according to the present invention, the electrode can be stably formed without a step height in the bezel, by forming the bezel to have a slope portion, so that disconnection or cracks of electrodes can be prevented.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
a transparent substrate divided into an active area and a non-active area, which is an outer region of the active area;
electrodes formed on one surface of the transparent substrate; and
a bezel formed in the non-active area of one surface of the transparent substrate,
wherein the bezel is formed of a bezel composition containing silane and a pigment

2. The touch panel as set forth in claim 1, wherein the bezel includes a slope portion slopingly formed on a lateral end part thereof.

3. The touch panel as set forth in claim 2, wherein the slope portion has a slope in which a height of the slope portion becomes gradually decreased toward the active area.

4. The touch panel as set forth in claim 3, wherein an angle between one surface of the transparent substrate and a slope surface of the slope portion is 10°˜80°.

5. The touch panel as set forth in claim 1, wherein the electrode is formed throughout the active area and the non-active area of the transparent substrate, and formed along one surface of the bezel.

6. The touch panel as set forth in claim 1, wherein the electrode includes:
a touch electrode formed in the active area of the transparent substrate; and
an electrode wire formed in the non-active area of the transparent substrate, the electrode wire being formed along one surface of the bezel.

7. The touch panel as set forth in claim 1, further comprising a shielding layer formed of an insulating material between the bezel and the electrode.

8. The touch panel as set forth in claim 1, wherein the bezel composition further contains a pigment dispersant.

9. The touch panel as set forth in claim 1, wherein the bezel composition further contains a binder resin.

10. The touch panel as set forth in claim 9, wherein the bezel composition further contains a solvent.

11. The touch panel as set forth in claim 10, wherein the bezel composition further contains a photo-polymerizable compound and a photo-initiator.

12. The touch panel as set forth in claim 11, wherein the bezel composition further contains one or more additives of a polymer compound, a hardener, a surfactant, an adhesion promoter, an anti-oxidant, a UV absorbent, and an anti-cohesive agent.

13. The touch panel as set forth in claim 1, wherein the pigment includes titanium dioxide (TiO₂) or carbon black.
